(19) United States
(12) Patent Application Publication
(10) Pub. No.: US 2015/0204443 A1
(43) Pub. Date: Jul. 23, 2015

(54) Manual Shift Transmission Control

(71) Applicant: TREMEC Corporation, Plymouth, MI (US)

(72) Inventor: Kevin Ryan, South Lyon, MI (US)

(73) Assignee: TREMEC Corporation, Plymouth, MI (US)

(21) Appl. No.: 14/532,104

(22) Filed: Nov. 4, 2014

Related U.S. Application Data
(60) Provisional application No. 61/900,950, filed on Nov. 6, 2013.

(51) Int. Cl. F16H 63/34; F16H 63/20; F16H 61/18

(52) U.S. Cl. CPC F16H 63/34; F16H 61/18; F16H 63/20; F16H 2061/185

(57) ABSTRACT

A manually shiftable transmission includes a blocking mechanism to prevent unintended engagement of a first forward gear set. An electronic controller is provided for moving the blocking mechanism into an unblocking position. A manually operable release switch is provided to generate a signal to an electronic controller to move the blocking mechanism into the unblocking position when an intentional engagement of the first gear set is desired. The transmission may also include a mechanism to inhibit engagement of a reverse gear set. The electronic controller and manually operable release switch may be used to move the reverse gear inhibiting mechanism to an uninhibited position.

### CROSS-REFERENCE TO RELATED APPLICATION

This application claims the benefit of U.S. Provisional Application No. 61/900,950 filed Nov. 6, 2013, the disclosure of which is incorporated herein by reference.

### FIELD OF THE INVENTION

The present invention relates generally to transmissions, and more particularly to shift controls for manually shifted transmissions.

### BACKGROUND OF THE INVENTION

Transmissions, such as those widely used in vehicles, are well know in the art. Transmissions, also known as gearboxes, typically include a case or housing containing an input shaft, an output shaft, and a plurality of meshing gears. The meshing gears contained within the transmission case are of varying size to provide a plurality of gear ratios. By appropriately shifting among these various gear ratios, acceleration and deceleration of the vehicle can be accomplished in a smooth and efficient manner.

Manually shifted vehicle transmissions, that is, those in which gear engagement is shifted in response to some physical exertion by an operator, are well known and are often preferred various types of vehicles, such as heavy duty trucks and racing or competition vehicles. Many transmission structures are known for manually shifting among the various gear ratios. In a conventional manual transmission, the driver moves an upper portion of a pivotable shift lever to effect shifting of the gears. In response thereto, a lower portion of the shift lever engages and moves one or more shift rails provided within the transmission. Shift rails are typically supported within the transmission case for sliding movement from a central or neutral position forward to one gear set engaging position or rearward to another gear set engaging position. Shift forks attached to a shift rail engage collars connected to various clutches to connect and disconnect the gear sets with various shafts. The initial selection and subsequent movement of a shift rail causes certain sets of gears to be connected between the input shaft and the output shaft to provide a desired output gear ratio.

Typically, manually shifted transmission gear ratio positions are arranged in pairs of shift rail movement paths, with movement of the shift rail forward or backward out of a neutral position effective to engage one set of gears. For example, in a typical six speed transmission, the first and second gear ratios are located in a first path, the third and fourth gear ratios are located in a second path, and the fifth and sixth gear ratios are located in a third path. A reverse gear may be located on a separate path or on a path along with another forward ratio. For example, in a five forward speed transmission, the reverse gear may be located on the same path as that used to engage the first or fifth gear sets.

Human error may be introduced during manual shifting of the shift lever. A common problem is shifting a transmission to an unintended gear, such as shifting into a reverse gear when a forward gear is intended. This could lead to disastrous results. Several types of reverse gear lockout safety systems have been developed to alleviate such problems.

Another problem is downshifting into an unintended gear. Downshifting is common in racing or competition vehicles to maximize vehicle performance. For example, downshifting from fourth gear to third gear would be common to slow the vehicle for a turn and put the vehicle in a better gear for acceleration when the vehicle comes out of the turn. However, it is possible that the driver may mistakenly downshift the transmission by moving the shift lever into an undesired path of movement. This is not uncommon in racing or competition vehicles because of the intensity of the racing event. Such inadvertent downshifting may result in undesirable consequences. For example, downshifting from fourth gear to first gear (instead of third gear) would cause the vehicle engine to unacceptably increase engine speed, possibly causing damage to the engine and to the vehicle's main friction clutch.

### SUMMARY OF THE INVENTION

The present invention is a manually operable transmission, such as a transmission for racing or competition vehicles. The transmission includes standard components such as a housing, input and output shafts, and one or more shift rails that selectively clutch various gear sets having various gear ratios for driving engagement of the input and output shafts. A manually operable shift lever is pivotally mounted to drivingly engage a shift rail assembly to selectively effect engagement of the various gear sets.

The transmission includes a blocking mechanism selectively movable between a blocked position wherein the shift lever is prevented from drivingly connecting a first forward gear set between the input shaft and the output shaft, and an unblocked position in which the shift lever is free to cause the first forward gear set to drivingly connect the input shaft and the output shaft. An electronic controller is provided for moving the blocking mechanism into the unblocked position. A manually operable release switch is provided to generate a signal to the electronic controller to move the blocking mechanism into the unblocked position when an intentional engagement of the first gear set is desired. Preferably, the release switch is a momentary release switch that operates a solenoid to allow the blocking mechanism to move into the unblocked position only for so long as the switch is activated.

The transmission may also include a reverse gear inhibiting mechanism selectively movable between an inhibiting position inhibiting the shift lever from engaging a reverse gear set and an uninhibited position wherein the inhibiting mechanism allows the shift lever to engage the reverse gear set. A second solenoid may be provided to control, within limits, the reverse gear inhibiting mechanism. The same signal generated by the manually operable release switch may be used to simultaneously move the reverse gear inhibiting mechanism to an uninhibited position.

Various aspects of this invention will become apparent to those skilled in the art from the following detailed description of the preferred embodiment, when read in light of the accompanying drawings.

### BRIEF DESCRIPTION OF THE DRAWINGS

FIGS. 1A and 1B together are a cross-sectional view of a transmission in accordance with the present invention.

FIG. 2 is a cross-sectional view of a portion of the transmission of FIGS. 1A and 1B taken along line 2-2.

FIG. 3 is a perspective view of the gate control of FIG. 2.

FIG. 4 is plan view of the guide plate of FIG. 2.

FIG. 5 is a partial cross-sectional view of the transmission of FIGS. 1A and 1B taken along line 5-5.

FIG. 6 is a view of the reverse shift rail of the transmission of FIGS. 1A and 1B.

FIG. 7 is a partial cross-sectional view of the transmission of FIGS. 1A and 1B taken along line 7-7.

FIG. 8 is a schematic view of controls for the transmission of FIGS. 1A and 1B.

### DESCRIPTION OF PREFERRED EMBODIMENTS

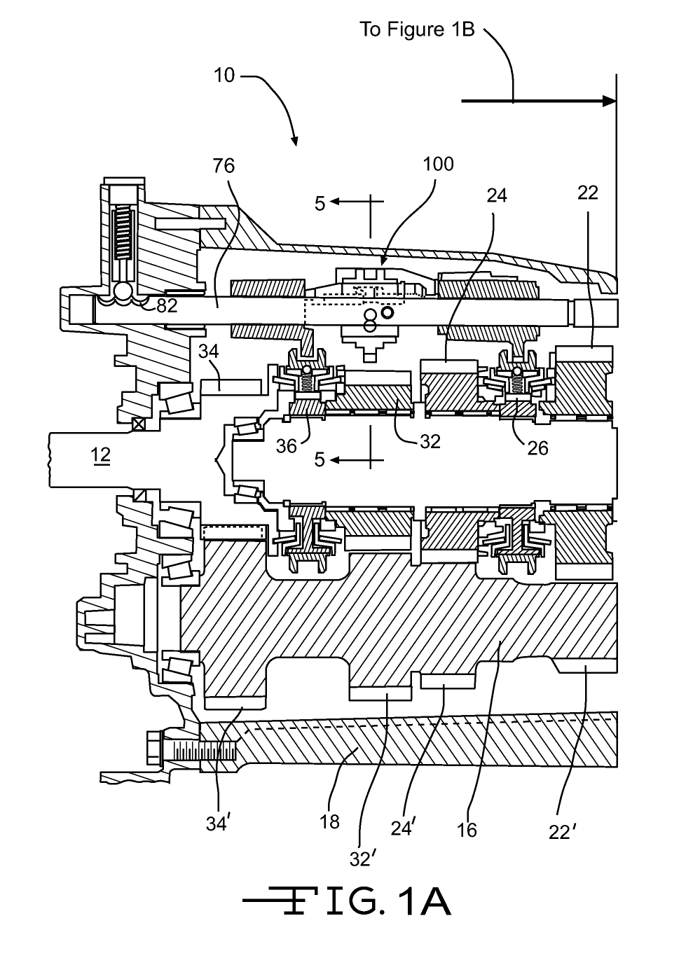

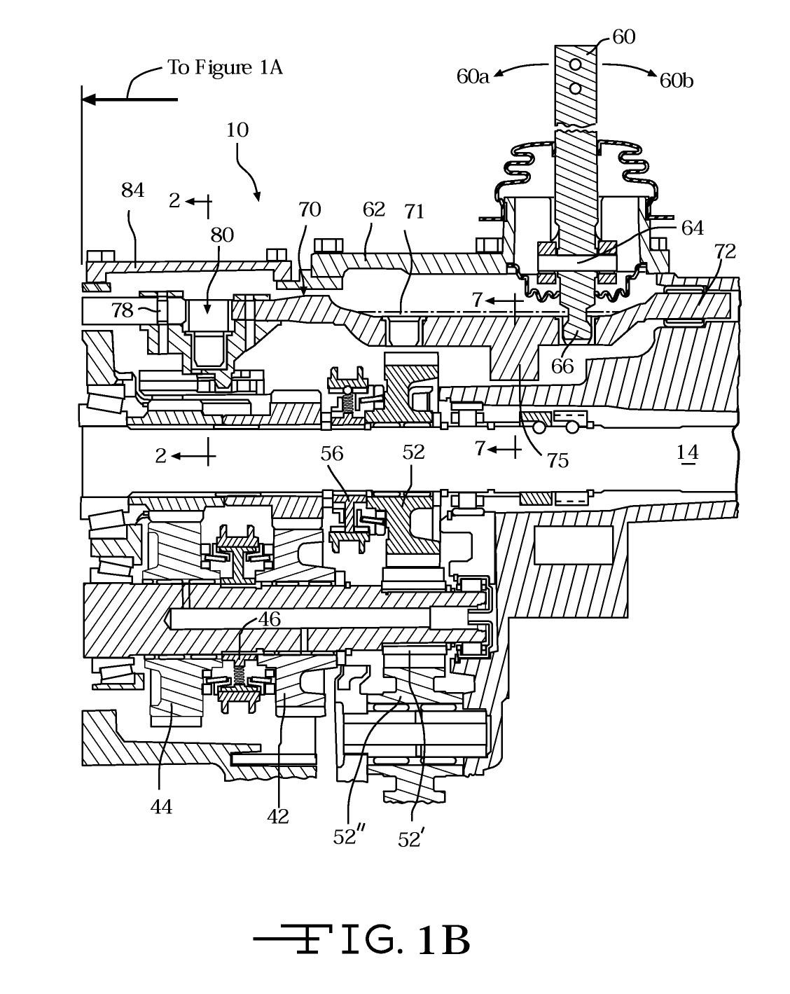

Referring to FIG. 1A and 1B, a transmission 10 is, in large measure, a conventional manually shifted vehicular transmission adapted to provide several forward gear ratios between an input shaft 12 at the forward end of the transmission and an output shaft 14, as is well known in the art. The transmission 10 has a single countershaft 16, six forward gear ratios and one reverse gear ratio, although the present invention may be applied to multi-countershaft transmissions, range boxes and nearly any number of gear ratios. Transmission housing 18 encases the various components of the transmission 10.

As is well known in the art, various gears may be selectively clutched to the output shaft 14 to drive the output shaft at various speed ratios relative to the input shaft speed. For example, first gear set 22, 22′ and second gear set 24, 24′ may be selectively clutched to output shaft 14 by clutch 26. Third gear set 32, 32′ and fourth gear set 34, 34′ may be selectively clutched to output shaft 14 by clutch 36. Fifth gear set 42, 42′ and sixth gear set 44, 44′ may be selectively clutched to output shaft 14 by clutch 46. Reverse gear set 52, 52′, 52″ (idler gear 52″ shown out of position for illustrative purposes) may be selectively clutched to output shaft 14 by clutch 56. The various clutches are drivingly connected to the shift rail assembly 70 by shift forks, as is well known in the art.

Transmission 10 may be manually shifted among the various gear ratios through manual shift lever 60 mounted on shift lever housing 62. The shift lever 60 may pivot forward 60a and backward 60b (as viewed in FIGS. 1A and 1B) as well as transversely about a pivot pin 64. The lower end of the shift lever 60 is formed with a finger 66 that drivingly engages a shift rail assembly 70. The shift rail assembly 70 includes a rear shift rail 72 having an aperture 74 for receiving the shift lever finger 66. The shift rail assembly 70 also includes a forward shift rail 76 drivingly connected to the rear shift rail 72 by pins 78 which extend through a gate member 80. Shift rail 72 includes a reverse paddle 75, the purpose of which will be explained later.

As is well known in the art, transverse movement of the shift lever 60 about the pivot pin 64 causes rotation of the shift rail assembly 70 about rotational axis 71 to select pairs of gear sets that can be engaged. Forward and backward pivoting of the shift lever 60 moves the shift rail assembly 70 axially along axis 71 to cause engagement of one of the pairs of selected gear sets with the output shaft 14. A spring and detent system 82 provides operator feel for the forward, neutral and rearward positions of the shift rail assembly 70.

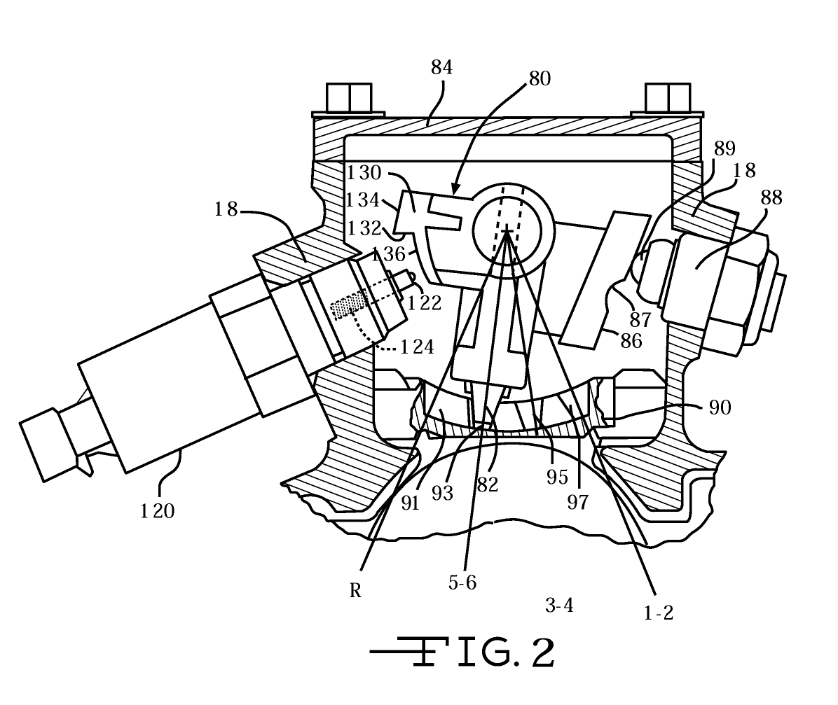

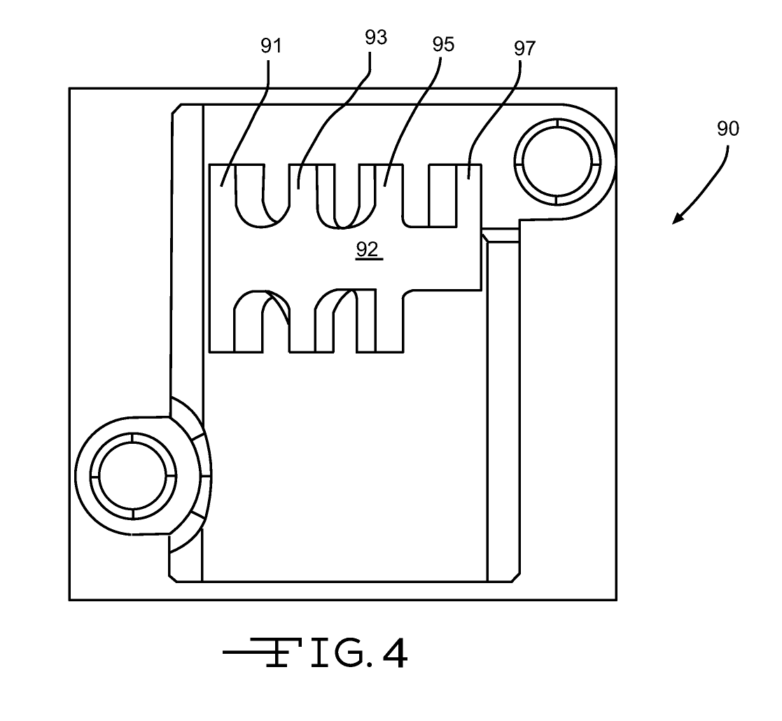

Selection of pairs of gear sets to engage the output shaft 14 is made through the gate 80. Referring to FIGS. 2, 3 and 4, the gate 80 includes a selector finger 82 that travels within a guide plate 90. The gate 80 may be cast, machined or formed from powdered metal. Guide plate 90 is secured to the transmission housing 18 by bolts (not shown). A cover plate 84 is bolted to the housing 18 for assembly purposes and to provide access to the gate 80. When the shift lever 60 is in a neutral position in which no gear set is engaged with the output shaft, selector finger 82 is in the neutral track 92 of the guide plate 90. In this position, transverse movement of the shift lever 60 causes the selector finger 82 to pivot between various guide plate tracks 91, 93, 95, 97.

The guide plate tracks limit rotation of the shift rail assembly 70 when the shift lever 60 is in a forward or backward position corresponding to engagement of a gear set. The guide plate tracks correspond to rotational positions of the shift rail assembly 70. Guide plate track 97 corresponds to forward gear set pairs for first and second gears (i.e. gear ratios); guide plate track 95 corresponds to forward gear set pairs for third and fourth gears; guide plate track 93 corresponds to forward gear set pairs for fifth and sixth gears; guide plate track 91 corresponds to the reverse gear set.

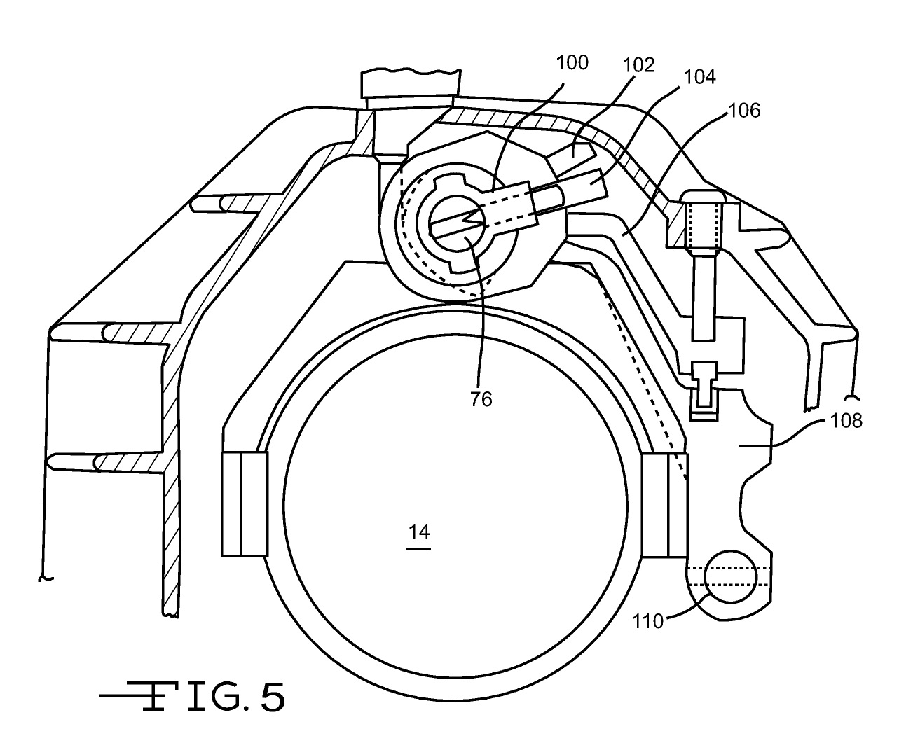

Referring to FIGS. 1 and 5, a selector finger 100 is rigidly attached to the forward shift rail 76. Rotation of the shift rail 76 causes the finger 100 to select a forward gear set pair lever 102, 104 or 106 or reverse gear lever 108 for driving engagement with the shift lever assembly 70. When a forward gear pair lever 102, 104, or 106 is selected, the shift rail assembly 70 will be drivingly engaged with the clutch collars and shift forks of the respective forward gear sets. Forward and backward pivotal movement of the shift lever 60 will force backward and forward movement of the shift rail assembly 70 causing clutching of one of the forward gears sets of the selected pair with the output shaft 14.

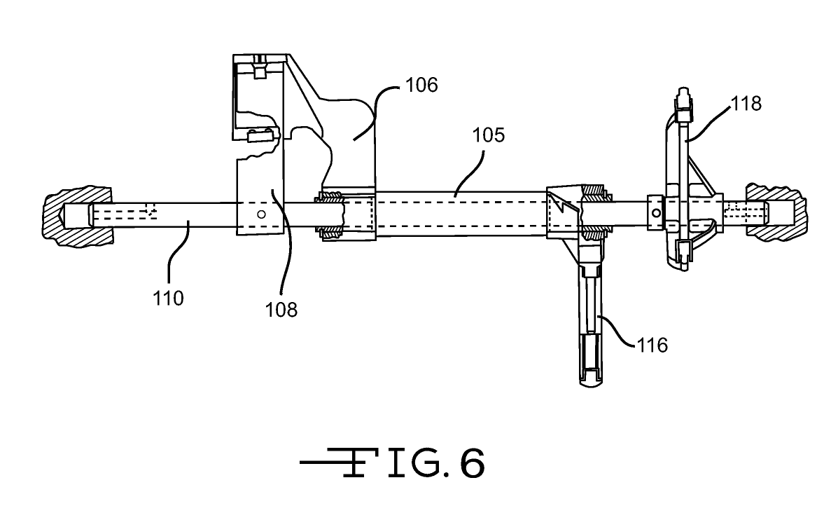

Referring also to FIG. 6, a separate shift rail assembly 110 is provided to engage the fifth and sixth gear sets and the reverse gear set. When selector finger 100 is engaged with the lever 106, axial movement of the shift lever 60 causes axial movement of the shift rail 105 and shift fork 116, and engagement of the fifth or sixth gear sets with output shaft 14. When selector finger 100 engages the reverse lever 108, axial movement of the shift lever 60 causes axial movement of the shift rail 110 and shift fork 118, and engagement of the reverse gear set with output shaft 14.

### Forward Gate Control

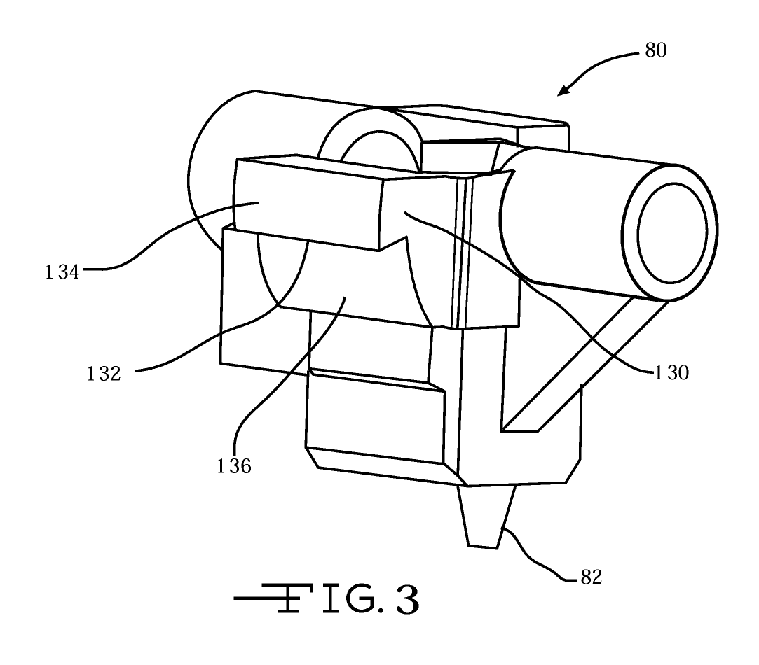

Referring again to FIGS. 2 and 3, gate 80 is rigidly connected to shift rail assembly rails 72 and 76 by pins 78 for rotational and axial movement in response to shift lever 60 movements. Rotational movement of the gate 80 aligns the shift finger 82 for axial travel in one of the gear guide tracks 91, 93, 95, or 97. Gate 80 includes an integral cam track 86. A centering mechanism in the form of a ball and spring detent mechanism 88 is threaded into the housing 18, with the ball 89 engaging the cam track 86 under a spring load. The cam track 86 has a neutral position 87 that provides feel to the shift lever 60 at the neutral track 92 of the guide plate 90.

A track block extension 130 is integrally formed on the gate 80 opposite the cam track 86. A twelve volt gate control solenoid 120 is threaded into housing 18 opposite the detent mechanism 88. The solenoid includes a pin 122 that is retractable when power is applied to the solenoid, as is well known in the art. A spring 124 forces the pin 122 to its fully extended position as shown in FIG. 2 when power is not applied to the solenoid.

The track block 130 includes a blocking surface 132 for selective engagement with the solenoid pin 122. The solenoid pin 122 and blocking surface 132 are oriented such that the selector finger 80 cannot be rotated to the first and second gear set track 97 unless the pin 122 is retracted, that is, unless power is applied to the solenoid. The blocking extension 130 has an undercut surface 136 adjacent to blocking surface 132. The pin 122 cannot engage the undercut surface 136 when fully extended, thereby permitting free movement of the selector finger among track guide tracks 91, 93, and 95. The solenoid 120 is designed such that the pin 122 has sufficient strength to carry the side load which will be applied by the selector 80 through the blocking surface 132. A twelve volt solenoid can be used, but other sizes and voltages may be used.

In operation of the transmission, the operator must apply power to the solenoid 120 in order to access the first pair of gear sets. The first pair of gear sets includes the first gear set 22, 22′ and the second gear set 24, 24′, which provide the lowest output shaft speed ratios. This pair of gear sets is typically engaged for the initial launch of a vehicle. If the first forward gear set 22, 22′ is engaged, a shift to the second forward gear set 24, 24′ will be possible without powering the solenoid because the solenoid pin 122 will be restricted from extending by slide surface 134 on the track block extension.

When the transmission is shifted from the second forward gear set 24, 24′ to the third forward gear set 32, 32′ or fourth forward gear set 34, 34′, the selector finger 82 will move to gate track 95 with minimal resistance from the solenoid pin 122 as it slides along the slide surface 134. However, when the selector finger 82 reaches the gear set track 95, the blocking surface 132 will have already passed the pin 122, allowing the pin to extend fully under the force of solenoid spring 124.

After the selector finger 82 is moved from the guide track 97, the gate 80 will prevent the transmission operator from returning the selector finger 82 to guide track 97 because the gate 80 will be blocked by the pin 122 engaging the blocking surface 132. Of course, activating the solenoid will retract the pin 122, thereby allowing the selector finger 82 access to the track 97 ultimately access to the associated forward gear sets.

### Reverse Inhibiting Mechanism

As previously explained, reverse gear set 52 can be clutched to the output shaft 18 through the output clutch 56. To position the shift lever 60 so that the gate control 80 is in the reverse guide track 91 (FIG. 2), selector finger 100 must engage the reverse lever 108. A reverse inhibiting mechanism 140 prevents inadvertent access to the reverse gear guide track 97.

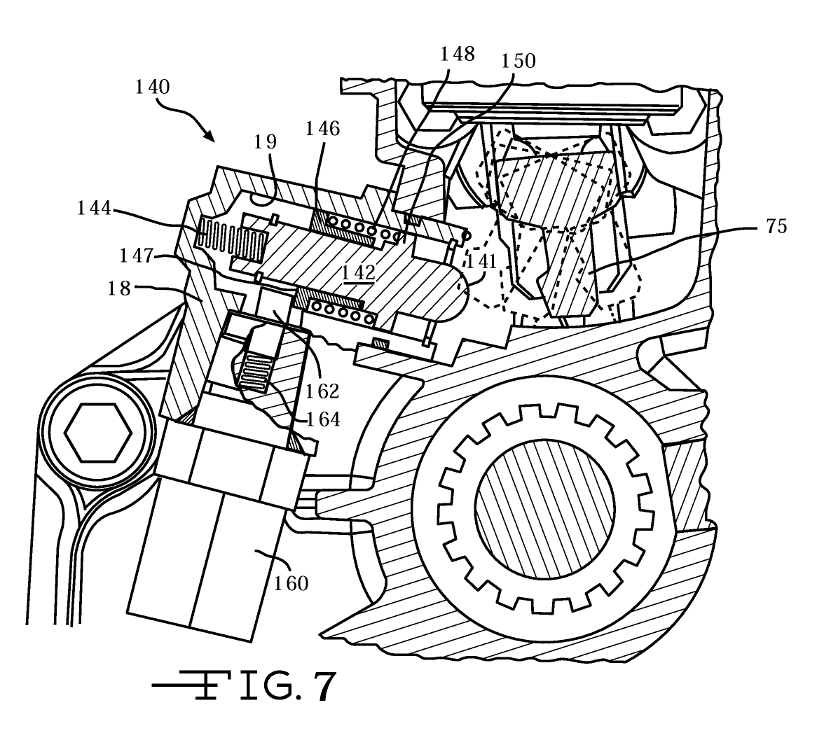

Referring to FIG. 7, mechanism 140 includes a plunger 142 seated in a cylindrical opening 19 in the housing 18. The plunger has a forward surface 141 and an integral annular flange 150 which is sized to allow a close fit in the opening 19. When the plunger 142 is in an extended position, the forward surface 141 will engage the reverse paddle 75 and block the reverse paddle 75 from rotating to an extreme position, thereby blocking the selector finger 80 from entering guide track 91. Plunger 142 is biased into the blocking position shown in FIG. 7 by biasing spring 144.

A collar 146 surrounds the plunger 142. A spring 150 is positioned to react against the collar 146 and the plunger flange 150. The spring 150 biases the collar 148 axially away from the plunger flange 150. When the plunger 140 is in an uninhibited position, the spring 144 will bias the plunger to block the reverse paddle from a position for engaging the reverse gear set. In this configuration, the shift lever 60 easily will be able to overcome the force of spring 144 to move the plunger from the blocking position to allow access the reverse shift rail 110.

A reverse inhibitor solenoid 160 is threaded into the housing 18. Reverse inhibitor solenoid 160 has an extendible pin 162. Reverse inhibitor solenoid 160 is a twelve volt solenoid identical to the gate control solenoid 120; however, the two solenoids do not have to be identical. The pin 162 is retractable when power is applied to the solenoid 160. A solenoid spring 164 forces the pin 162 to its fully extended position as shown in FIG. 7 when no power is applied to the solenoid. When the reverse paddle 75 is not engaged with the plunger 142, solenoid pin 162 is extended by the solenoid spring into the path of collar 146. If the collar 146 is moved away from the reverse paddle 75, the collar flange surface 147 will engage the pin 162, thereby blocking the plunger from retracting unless the force of spring 148 is overcome.

The intent of this design is that the spring force 148 will be sufficient to prevent an unintentional shift engaging the reverse gear set, but not an absolute restriction. For safety reasons, it is preferred that the transmission operator be capable of engaging the reverse gear set manually if this is truly intended by the operator, but such intention must be demonstrated by overcoming the force of spring 148. The reverse inhibitor mechanism merely inhibits engagement of the reverse gear set, but does not absolutely prevent engagement.

### Controls

The gate control solenoid 120 and reverse lockout solenoid 160 may be controlled simultaneously. For example, a switch may be used by a vehicle operator to momentary engage both solenoids simultaneously, thereby allowing engagement of the first pair of gear sets as well as the reverse gear set. The solenoids 102 and 160 are identical, but solenoids of different voltages or types may be used provided the controller 170 is adapted accordingly. Solenoids are commonly known and used and are readily available, such as Fema Corp. solenoid 51160.

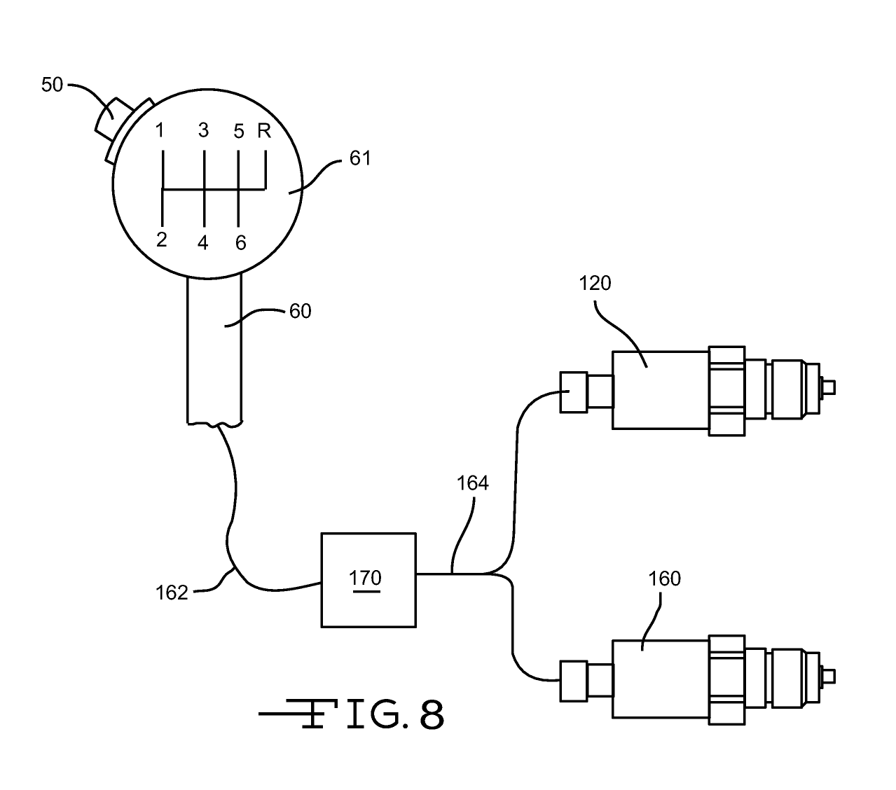

Referring to FIG. 8, a thumb button switch 50 on a shift lever knob 61 may be used to send a signal to an electronic controller 170 to provide a simultaneous momentary signal to each of the solenoids 120 and 160 through appropriate wiring 162, 164 connected to and powered by a vehicle electrical system. Of course, alternatively, separate switches also may be use to power the separate solenoids.

This invention relates is particularly applicable to transmissions for completion or racing vehicles. The gate 80 limits the ability of a vehicle driver to downshift into the lower gear ratios without activating solenoid 120 which controls the blocking mechanism 80. As such, the shift gate control between the first and second gear ratios is referred to a competition gate. The momentary release switch moves the solenoid pin 122 to its retracted position for a relatively short period of time, thereby allowing a driver to manually override the downshift limiting structure in a quick and easy manner for a relatively short period of time.

The descriptions of specific embodiments of the invention herein are intended to be illustrative and not restrictive. The invention may be practiced otherwise than as specifically explained and illustrated without departing from its spirit or scope as defined by the appended claims.

What is claimed is:

1. A manually operable transmission comprising:
a transmission housing,
an input shaft mounted for rotation in the housing,
a output shaft mounted for rotation in the hosing,
a first forward gear set and a second forward gear set, each gear set selectively engagable to drivingly connect the input shaft and output shaft,
a shift rail mounted for movement relative to the housing for selectively drivingly connecting the first forward gear set or the second forward gear set between the input an output shafts,
a manually operable shift lever pivotally mounted on the housing, the shift lever drivingly engaging the shift rail,
a blocking mechanism selectively movable between a blocked position wherein the shift lever is prevented from drivingly connecting a first forward gear set between the input shaft and the output shaft, and an unblocked position wherein the shift lever may cause the first forward gear set to drivingly connect the input shaft and the output shaft,
an electronic controller for moving the blocking mechanism into the unblocked position,
a manually operable release switch for generating a signal to the electronic controller to move the blocking mechanism into the unblocked position.

2. The transmission as defined in claim 1 wherein the release switch is a manually operable momentary release switch for retaining the blocking mechanism in the unblocked position only for so long as the momentary release switch is activated.

3. The transmission as defined in claim 2 wherein deactivation of the momentary release switch causes the blocking mechanism to move into the blocked position.

4. The transmission as defined in claim 3 wherein the shift rail is selectively engageable with the first forward gear set and the second forward gear set, wherein the blocked position prevents the shift lever from engaging the first forward gear set.

5. The transmission as defined in claim 4 wherein the forward gear shift rail assembly is selectively engageable with a third gear set, wherein the blocking mechanism prevents the shift lever to move from engaging the third forward gear set to engaging the first forward gear set without activation of the momentary release switch.

6. The transmission as defined in claim 5 wherein each of the first, second and third forward gear sets produce different forward gear ratios when drivingly engaged between the input and output shafts, and wherein the first forward gear set produces a lower gear ratio than the second gear set, and the second gear set produces a lower gear ration that the third gear set, whereby downshifting from the second or third forward gear set is blocked unless the release switch is activated.

7. The transmission as defined in claim 1 further comprising a reverse shift rail assembly, a reverse gear set engageable by the reverse shift rail assembly, a reverse gear inhibiting mechanism selectively movable between an inhibiting position inhibiting the shift lever from engaging the reverse shift rail assembly and an uninhibited position wherein the inhibiting mechanism allows the shift lever to engage the reverse shift rail assembly uninhibitedly.

8. The transmission as defined in claim 7 wherein movement of the reverse gear inhibiting mechanism between the inhibited and uninhibited positions is effected by the electronic controller.

9. The transmission as defined in claim 8 further comprising a blocking mechanism solenoid and a reverse inhibitor solenoid, wherein the blocking mechanism solenoid and the reverse inhibitor solenoid are simultaneously actuated by the electronic controller.

10. The transmission as defined in claim 9 further comprising a release switch for generating a signal to the electronic controller to move the blocking mechanism into the unblocked position and the reverse inhibiting mechanism into the uninhibited position.

11. The transmission as defined in claim 1 further comprising:
a reverse gear shift rail assembly,
a reverse gear set engagable by the reverse gear shift rail assembly to drivingly connect the input shaft and output shaft, the shift lever selectively engageable with the reverse gear shift rail assembly,
a reverse gear inhibiting mechanism selectively movable between an inhibiting position wherein the reverse gear inhibiting mechanism inhibits the shift lever from engaging the reverse shift rail assembly and an uninhibited position wherein the inhibiting mechanism allows the shift lever to engage the reverse shift rail assembly uninhibitedly,
wherein movement of the blocking mechanism between the blocked and unblocked positions is effected by a first solenoid,
wherein movement of the reverse gear inhibiting mechanism between the inhibited and uninhibited positions is effected by a second solenoid,
wherein the first and second solenoids are actuated by an electronic controller,
the transmission further comprising a release switch for generating a signal to the electronic controller to simultaneously move the blocking mechanism into the unblocked position and the inhibiting mechanism into the uninhibited position.

12. The vehicle transmission as defined in claim 11 wherein the release switch is a momentary release switch manually operable by the vehicle operator for retaining the blocking mechanism in the unblocked position and the inhibiting mechanism into the uninhibited position only for so long as the vehicle operator activates the momentary release switch.

13. The vehicle transmission as defined in claim 12 wherein deactivation of the momentary release switch by the vehicle operator causes the blocking mechanism to move into the blocked position and the inhibiting mechanism into the uninhibited position.

14. A manually operable transmission comprising:
a transmission housing,
an input shaft mounted for rotation in the housing,
a output shaft mounted for rotation in the hosing,
a shift rail mounted for movement relative to the housing,
a manually operable shift lever pivotally mounted on the housing, the shift lever drivingly engaging the shift rail,
a first pair of forward gear sets, the first pair comprising a first forward gear set and a second forward gear set, each of the first and second forward gear sets selectively engagable by the shift rail to drivingly connect the input shaft and output shaft,
a blocking mechanism selectively movable between a blocked position wherein the shift lever is prevented from drivingly connecting the first pair of forward gear sets between the input shaft and the output shaft, and an unblocked position wherein the shift lever may cause driving connection of the input shaft and the output shaft through the first pair of forward gear sets,
an electronic controller for moving the blocking mechanism into the unblocked position,
a manually operable release switch for generating a signal to the electronic controller to move the blocking mechanism into the unblocked position.

15. The manually operable transmission of claim 14 further comprising a second pair of forward gear sets, the second pair comprising a third forward gear set and a fourth forward gear set, each of the third and fourth forward gear sets selectively engagable by the shift rail to drivingly connect the input shaft and output shaft, wherein the blocking mechanism is biased into the blocked position when the input and output shafts are drivingly connected through the third or fourth forward gear sets.

16. The manually operable transmission of claim 15 further comprising a reverse gear set selectively engagable by the shift rail to drivingly connect the input shaft and output shaft, and a reverse gear inhibiting mechanism selectively movable between an inhibiting position wherein the shift lever is inhibited from drivingly connecting the reverse gear set between the input shaft and the output shaft, and an uninhibited position wherein the shift lever may cause driving connection of the input shaft and the output shaft through the reverse gear set, wherein movement of the a reverse gear inhibiting mechanism into the uninhibited position is controlled in part by the electronic controller.

17. The manually operable transmission of claim 16 wherein the manually operable release switch is a momentary release switch for simultaneously retaining the blocking mechanism in the unblocked position and the reverse gear inhibiting mechanism in the uninhibited position only for so long as the momentary release switch is activated.

18. The manually operable transmission of claim 17 wherein the reverse gear inhibiting mechanism comprises a spring biasing the mechanism toward the blocked position, wherein the spring biasing force may be overcome by sufficient force applied to the shift lever.

19. A manually operable transmission comprising:
a transmission housing,
an input shaft mounted for rotation in the housing,
a output shaft mounted for rotation in the hosing,
a first shift rail mounted for movement relative to the housing,
a second shift rail mounted for movement relative to the housing,
a manually operable shift lever pivotally mounted on the housing, the shift lever selectively drivingly engagable with the first and second shift rails,
a first pair of forward gear sets, the first pair comprising a first forward gear set and a second forward gear set, each of the first and second forward gear sets selectively engagable by the first shift rail to drivingly connect the input shaft and output shaft,
a second pair of forward gear sets, the second pair comprising a third forward gear set and a fourth forward gear set, each of the third and fourth forward gear sets selectively engagable by the second shift rail to drivingly connect the input shaft and output shaft,
a blocking mechanism selectively movable between a blocked position wherein the shift lever is prevented from drivingly engaging the first shift rail, and an unblocked position wherein the shift lever may drivingly engage the first shift rail,
an electronic controller for moving the blocking mechanism into the unblocked position,
a manually operable release switch for generating a signal to the electronic controller to move the blocking mechanism into the unblocked position.

20. The manually operable transmission of claim 19 further comprising:
a third shift rail selectively drivingly engagable by the shift lever,
a reverse gear set engagable by the third shift rail to drivingly connect the input shaft and output shaft,
a reverse gear inhibiting mechanism selectively movable between an inhibiting position wherein the shift lever is inhibited from drivingly connecting the reverse gear set between the input shaft and the output shaft, and an uninhibited position wherein the shift lever may cause driving connection of the input shaft and the output shaft through the reverse gear set,
wherein movement of the a reverse gear inhibiting mechanism into the uninhibited position is controlled in part by the electronic controller.
